(19) United States
(12) Patent Application Publication
(10) Pub. No.: US 2013/0078027 A1
(43) Pub. Date: Mar. 28, 2013

(54) ROTARY SHAFT STRUCTURE

(71) Applicants: AN SZU HSU, NEW TAIPEI CITY (TW); CHIEN NAN TSAI, NEW TAIPEI CITY (TW)

(72) Inventors: AN SZU HSU, NEW TAIPEI CITY (TW); CHIEN NAN TSAI, NEW TAIPEI CITY (TW)

(73) Assignee: FIRST DOME CORPORATION, NEW TAIPEI CITY (TW)

(21) Appl. No.: 13/241,964

(22) Filed: Sep. 23, 2011

(51) Int. Cl. F16C 11/04

(52) U.S. Cl. 403/113

(57) ABSTRACT

A rotary shaft structure includes a rotary shaft having at least one restriction section and a bridge provided with at least one stop section. The bridge includes a first bridge member and a second bridge member. Each of the first and second bridge members has a pivot section. The pivot sections together define an internal space or room for pivotally connecting with the rotary shaft. The first and second bridge members are formed with bolt holes. At least one retainer is assembled at the bolt holes. The rotary shaft is permitted to rotate within the space or room defined by the pivot sections. The restriction section and the stop section interference with each other to provide locating effect for the rotary shaft when not rotated.

### BACKGROUND OF THE INVENTION

1. Field of the Invention

The present invention relates generally to an improved rotary shaft structure applied to an electronic device, and more particularly to a rotary shaft structure including a rotary shaft with a restriction section and a bridge with a stop section. The restriction section and the stop section interference with each other to provide rotational and locating effect for the rotary shaft.

2. Description of the Related Art

Various conventional pivot pins or rotary shafts have been developed and applied to the covers, display screens or viewers of electronic devices such as mobile phones, laptops, PDA, digital image capturers and electronic books. The cover, display screen or viewer of the electronic device can be pivotally rotated around the pivot pin or rotary shaft between a closed position and an open position.

Such pivot pin or rotary shaft structure generally includes multiple gaskets, frictional plates and elastic members assembled on the rotary shaft. Two ends of the rotary shaft are secured with retainers respectively to avoid axial displacement of the components. The conventional pivot pin or rotary shaft structure can be located in a desired angular position immediately after rotated.

In the conventional rotary shaft structure, raised/recessed locating/insertion sections are formed on the gaskets, the frictional plates or other relevant components to provide locating effect for the rotary shaft. In operation, when the raised section is moved into the recessed section, the rotary shaft is located. However, when applied to a high-torque or large-size electronic product, the raised/recessed locating sections are subject to wear after a period of operation. This will deteriorate the locating effect.

Moreover, in the conventional rotary shaft structure, multiple gaskets and frictional plates and elastic rings or springs are assembled to store energy or release energy for providing rotational and locating effect for the pivot pin or rotary shaft. Such assembly is quite complicated and is difficult to assemble.

It is therefore tried by the applicant to provide an improved rotary shaft structure, which is applicable to a high-torque or large-size electronic product to provide more reliable locating effect. Therefore, the electronic product can be more stably used and the lifetime of the electronic product can be prolonged.

### SUMMARY OF THE INVENTION

It is therefore a primary object of the present invention to provide an improved rotary shaft structure with rotational and locating effect. The rotary shaft structure includes a rotary shaft and a bridge. The rotary shaft has at least one restriction section. The bridge is formed with at least one stop section corresponding to the restriction section. The bridge includes a first bridge member and a second bridge member. Each of the first and second bridge members has a pivot section. The pivot sections together define an internal space or room for pivotally connecting with the rotary shaft. The first and second bridge members are formed with bolt holes. At least one retainer is assembled at the bolt holes. The rotary shaft is permitted to rotate within the space or room defined by the pivot sections. The restriction section and the stop section interference with each other to provide locating effect for the rotary shaft when not rotated so as to overcome the conventional problem that the rotational and locating effect is not idealistic when applied to a high-torsion rotary shaft device.

In the above rotary shaft structure, the restriction section of the rotary shaft has the form of a channel extending along an axis of the rotary shaft. The stop section of the first bridge member is a ridge section corresponding to the restriction section. The restriction section of the rotary shaft permits the stop section of the first bridge member to enter into interference with the restriction section, whereby the rotary shaft can be truly located in the bridge.

In the above rotary shaft structure, the restriction section of the rotary shaft and the stop section of the bridge extend along the same axis. The restriction section has a length equal to that of the rotary shaft. The stop section has a length equal to the length (or width) of the bridge. The restriction section and the stop section cooperate with each other to form an interference system to improve the defects existing in the conventional device. In the conventional device, raised/recessed locating sections are formed on the gaskets and frictional plates as interference structures. Such structures are subject to wear and can hardly achieve reliable locating effect.

In the above rotary shaft structure, the first and second bridge members have wing sections positioned in horizontal reference axes. The wing sections extend from two sides of the pivot sections. The bolt holes are formed on the wing sections. The retainer is passed through the bolt holes of the wing sections of the first and second bridge members for adjusting the distance therebetween.

In the above rotary shaft structure, the retainer is equipped with an elastic member for providing an elastic pressing effect and an elastic shock range for the first and second bridge members. Accordingly, the rotary shaft has a movement range.

In the above rotary shaft structure, the rotary shaft has a first side and a second side defined on two sides of the restriction section. The distance between the first side and the center (circular center) of the rotary shaft is shorter than the distance between the second side and the center (circular center) of the rotary shaft. Therefore, when rotating the rotary shaft from the original state, the restriction section of the rotary shaft is easier to leave the stop section of the bridge from interference with the stop section. Accordingly, the user can save strength in operation.

In the above rotary shaft structure, the rotary shaft further has a third side and a fourth side formed on the sections of the rotary shaft, which sections are free from the restriction section. The distance between the third side or the fourth side and the center (circular center) of the rotary shaft is longer than the distance between the first side or the second side and the center (circular center) of the rotary shaft. Accordingly, the rotary shaft has a cross section substantially in the form of a cam. When rotating the rotary shaft from the original state, the restriction section of the rotary shaft is easier to leave the stop section of the bridge from interference with the stop section for a user to save strength in operation.

The present invention can be best understood through the following description and accompanying drawings, wherein:

### BRIEF DESCRIPTION OF THE DRAWINGS

FIG. 1 is a perspective assembled view of the rotary shaft and the bridge of the present invention;

FIG. 2 is a perspective exploded view according to FIG. 1;

FIG. 3 is a sectional assembled view according to FIG. 1, showing the relative positions of the stop section of the bridge, the retainer, the elastic member and the restriction section of the rotary shaft, also showing that the rotary shaft is positioned in a home position in the bridge;

FIG. 4 is a sectional assembled view according to FIG. 3, showing that the restriction section of the rotary shaft leaves the stop section of the bridge, also showing the movement of the bridge and the elastic member;

FIG. 5 is a sectional assembled view of another embodiment of the present invention, showing that the rotary shaft has a first side and a second side defined on two sides of each restriction section;

FIG. 6 is a sectional assembled view according to FIG. 5, showing that the rotary shaft is rotated to move the bridge and the elastic member;

FIG. 7 is a sectional assembled view of still another embodiment of the present invention, showing that the bridge is provided with two stop sections;

FIG. 8 is a sectional assembled view according to FIG. 7, showing that the rotary shaft is rotated;

FIG. 9 is a sectional assembled view of still another embodiment of the present invention, showing that the rotary shaft further has a third side and a fourth side formed on the sections of the rotary shaft, which sections are free from the restriction sections; and

FIG. 10 is a sectional assembled view according to FIG. 9, showing that the rotary shaft is rotated to move the bridge and the elastic member.

### DETAILED DESCRIPTION OF THE PREFERRED EMBODIMENTS

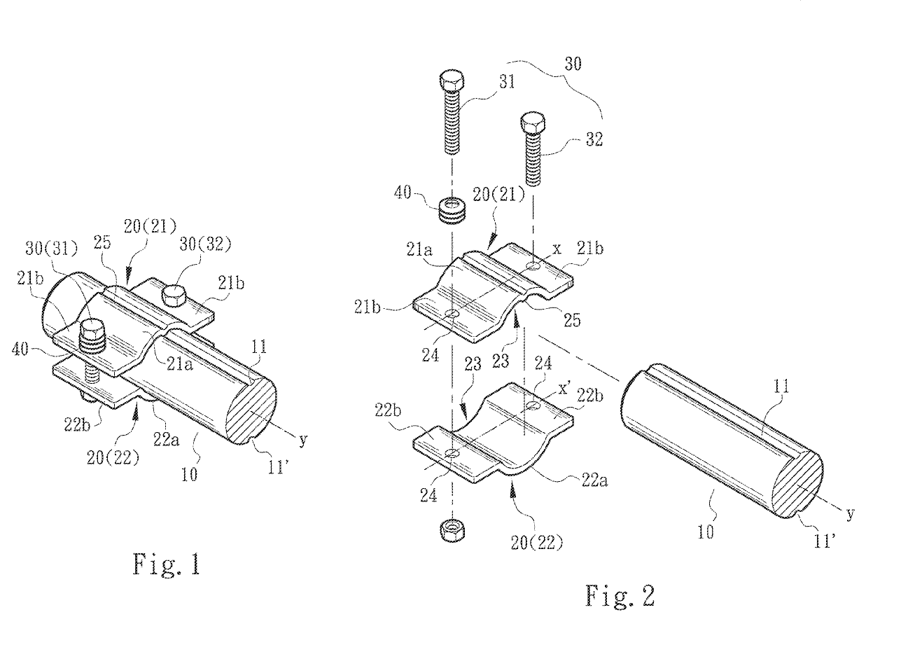

Please refer to FIGS. 1, 2 and 3. The rotary shaft structure of the present invention includes a rotary shaft 10 and a bridge 20. The rotary shaft 10 has the form of a cylindrical body. The rotary shaft 10 can be fixedly mounted on a cover, a screen or a display of an electronic device (not shown). In a preferred embodiment, the bridge 20 includes a first bridge member 21 and a second bridge member 22 symmetrical to the first bridge member 21. Each of the first and second bridge members 21, 22 has a pivot section 21a, 22a. The pivot sections 21a, 22a together define an internal space or room 23 for pivotally connecting with the rotary shaft 10.

As shown in the drawings, the pivot sections 21a, 22a of the first and second bridge members 21, 22 have a substantially arcuate or U-shaped cross section. The first and second bridge members 21, 22 further have wing sections 21b, 22b positioned in horizontal reference axes x, x′. The wing sections 21b, 22b extend from two sides of the pivot sections 21a, 22a. Each of the wing sections 21b, 22b is formed with a bolt hole 24. A retainer 30 is assembled at the bolt holes 24. The rotary shaft 10 can be rotated within the space or room 23 defined by the pivot sections 21a, 22a of the first and second bridge members and located at a desired angular position.

In this embodiment, there are two retainers 31, 32 corresponding to the wing sections 21b, 22b and the bolt holes 24. The retainers 30 (or 31, 32) have the form of a bolt. At least one of the retainers 30, (for example, retainer 31), is equipped with an elastic member 40. In this embodiment, the elastic member 40 has the form of a spring. The elastic member 40 is compressed at the bolt hole 24 of the wing section 21b of the first bridge member. It should be noted that the retainer 31 is equipped with the elastic member 40 to provide an elastic pressing effect and an elastic shock range for the first and second bridge members 21, 22. Accordingly, the rotary shaft 10 has a movement range for absorbing external force or mechanical shock so as to protect the rotary shaft 10 from damage.

In a preferred embodiment, the rotary shaft 10 has at least one restriction section 11. The restriction section 11 has the form of a channel extending along an axis y of the rotary shaft 10. The bridge 20 is formed with at least one stop section 25 corresponding to the restriction section 11. In this embodiment, the stop section 25 is a ridge section formed on (inner surface) of the pivot section 21a of the first bridge member. When rotating the rotary shaft 10, the stop section 25 of the bridge 20 (or the first bridge member 21) is permitted to enter the restriction section 11 of the rotary shaft 10 into interference with the rotary shaft 10. Accordingly, the rotary shaft 10 can be truly located in the bridge 20.

As shown in FIG. 2, the restriction section 11 of the rotary shaft 10 and the stop section 25 of the bridge 20 extend along the same axis y. The length of the restriction section 11 is equal to the length of the rotary shaft 10. The length of the stop section 25 is equal to the length (or width) of the bridge 20. The restriction section 11 and the stop section 25 cooperatively form an interference system to improve the defects existing in the prior art. In the prior art, raised/recessed locating sections are formed on gaskets and frictional plates as interference structures. Such structures are subject to wear and can hardly achieve reliable locating effect.

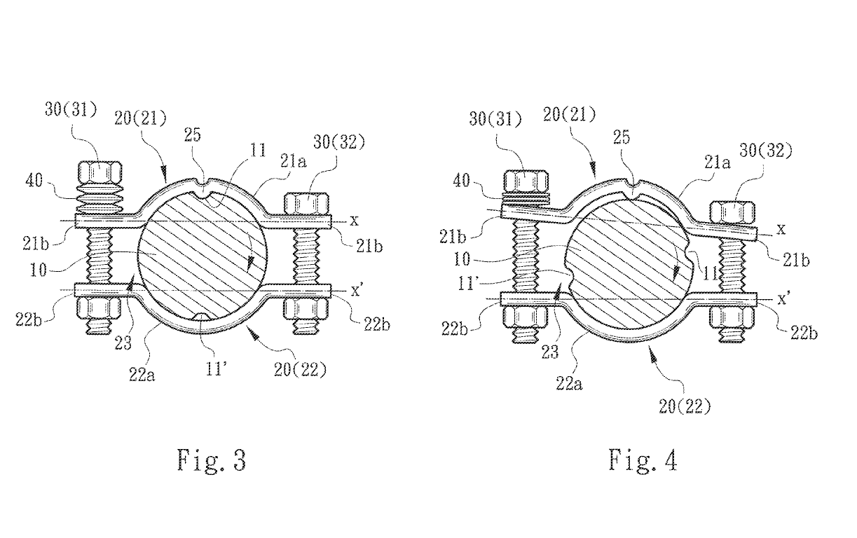

Please refer to FIG. 3. When the first and second bridge members 21, 22 are oppositely arranged, the retainer 31 with the elastic member 40 and the retainer 32 respectively pass through the bolt holes 24 of the wing sections 21b, 22b of the first and second bridge members 21, 22 for adjusting the distance between the first and second bridge members 21, 22 and the tightness.

FIG. 3 shows that the rotary shaft 10 is assembled with the bridge 20 in an initial state. In the initial state, the cover, screen or display of the electronic device is supposed to be closed to the electronic device. When a user rotates the cover, screen or display, the rotary shaft 10 is forcedly rotated in a direction of the arrow. At this time, the restriction section 11 of the rotary shaft 10 leaves the stop section 25 of the bridge 20 as shown in FIG. 4. Only when the user rotates back the rotary shaft 10, the stop section 25 is moved back into the restriction section 11 again and restored to the initial interference state.

It should be noted that the first and second bridge members 21, 22, the stop section 25, the rotary shaft 10 and the restriction section 11 cooperate with each other to achieve the following effects:
1. They are especially applicable to large-size electronic devices necessitating higher torque. This is because the assembly of the first and second bridge members 21, 22 and the retainer 30 can be adjusted in accordance with the torque or action force needed by the electronic product. That is, the first and second bridge members 21, 22 provide very large adjustment allowance for the retainer 30. By means of the retainer 30, the cooperation tightness between the first and second bridge members 21, 22 can be easily adjustable to meet the actual requirements of the rotary shaft 10. The cooperation tightness between the first and second bridge members 21, 22 and the rotary shaft 10 is adjustable to locate the rotary shaft 10 immediately after the rotary shaft 10 is rotated. This overcomes the problem existing in the conventional structure that the rotational and locating effect is not idealistic when applied to a high-torsion rotary shaft device.
2. FIG. 3 shows that the assembly of the first and second bridge members 21, 22 and the retainer 3 provides an interval range between the first and second bridge members 21, 22 for installing different sizes or specifications of rotary shafts 10. That is, different diameters or sizes of rotary shafts 10 can be installed in the space or room 23 defined between the first and second bridge members 21, 22. By means of the retainer 30, the tightness and rotational locating effect of the assembly can be adjusted.
3. The restriction section 11 of the rotary shaft 10 and the stop section 25 of the bridge 20 cooperate with each other to truly locate the cover, screen or display of the electronic device in a closed posit ion. Only under an operation force or external force greater than the interference force between the restriction section 11 and the stop section 25, the rotary shaft 10 can be rotated.
4. The retainer 31 cooperates with the elastic member 40 to provide a flexible movement range to the bridge 20. Therefore, when rotating the rotary shaft 10, the bridge 20 (or the first bridge member 21) is expanded to compress the spring for storing energy as shown in FIG. 4. When the stop section 25 of the bridge 20 enters the restriction section 11 of the rotary shaft 10 again, the elastic member 40 is decompressed to release energy. At this time, the bridge 20 is restored to its original state.

Please refer to FIGS. 3 and 4. The rotary shaft 10 is formed with two restriction sections 11, 11′ at 180-degree intervals. In this case, after the rotary shaft 10 is rotated by 180 degrees, the stop section 25 of the bridge 20 will enter the restriction section 11′ into interference with the restriction section 11′ to provide locating effect. At this time, the cover, screen or display of the electronic device is positioned in a fully open position. When a user operates the rotary shaft 10 to rotate back, the stop section 25 will go back to its home position into interference with the restriction section 11. At this time, the cover, screen or display of the electronic device is positioned in a fully closed position.

It should be noted that the rotary shaft 10 is formed with at least one restriction section 11 and the bridge 20 is provided with at least one stop section 25. FIGS. 3 and 4 show that the rotary shaft 10 has two restriction sections 11, 11′ and the bridge 20 is provided with one stop section 25.

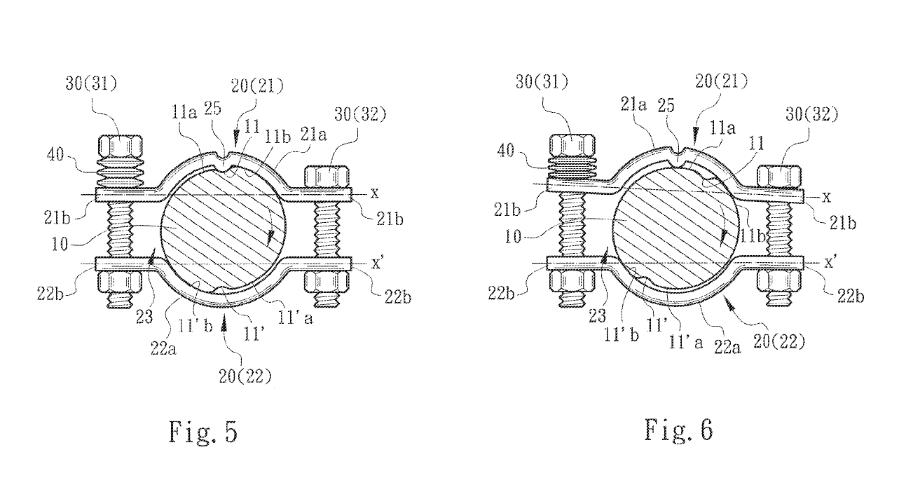

Please now refer to FIGS. 5 and 6. In a modified embodiment, the rotary shaft 10 has two restriction sections 11, 11′ and the bridge is cooperatively provided with one stop section 25 for illustration. The rotary shaft 10 has a first side 11a, 11′a and a second side 11b, 11′b defined on two sides of each of the restriction sections 11, 11′. The distance between the first side 11a, 11′a and the center (circular center) of the rotary shaft 10 is shorter than the distance between the second side 11b, 11′b and the center (circular center) of the rotary shaft 10. Therefore, when rotating the rotary shaft 10 from the original state, the restriction section 11, 11′ of the rotary shaft 10 is easier to leave the stop section 25 of the bridge 20 from interference with the stop section 25 (as shown in FIG. 6). Accordingly, the user can save strength in operation.

As shown in FIG. 6, when rotated, the rotary shaft 10 forces the bridge 20 (or the first bridge member 21) to expand to compress the elastic member 40 for storing energy. When the stop section 25 of the bridge 20 enters the restriction section 11 or 11′ of the rotary shaft 10 again, the elastic member 40 is decompressed to release energy. At this time, the bridge 20 is restored to its original state.

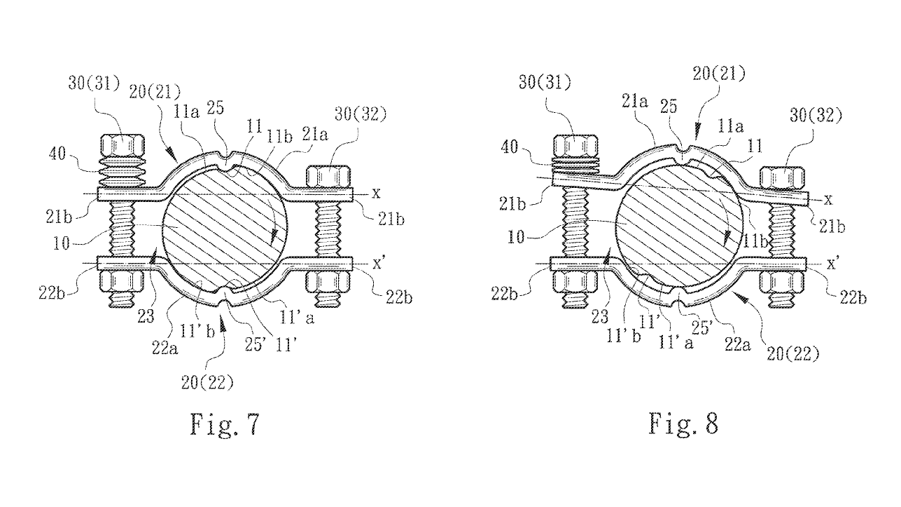

FIGS. 7 and 8 show a modified embodiment of the present invention. As shown in the drawings, the rotary shaft 10 has two restriction sections 11, 11′ and the bridge 20 is provided with two stop sections 25, 25′ formed on the first and second bridge members 21, 22 respectively. When the rotary shaft 10 is rotated, the restriction section 11 moves toward the stop section 25′, while the restriction section 11′ moves toward the stop section 25. At this time, the rotary shaft 10 forces the bridge 20 (or the first bridge member 21) to expand to compress the elastic member 40 for storing energy. When the stop section 25 of the bridge 20 enters the restriction section 11′ of the rotary shaft 10 and the stop section 25′ enters the restriction section 11 or when the rotary shaft 10 is rotated backward, the stop section 25 of the bridge 20 enters the restriction section 11 of the rotary shaft 10 and the stop section 25′ enters the restriction section 11′, the elastic member 40 is decompressed to release energy. At this time, the bridge 20 is restored to its original state.

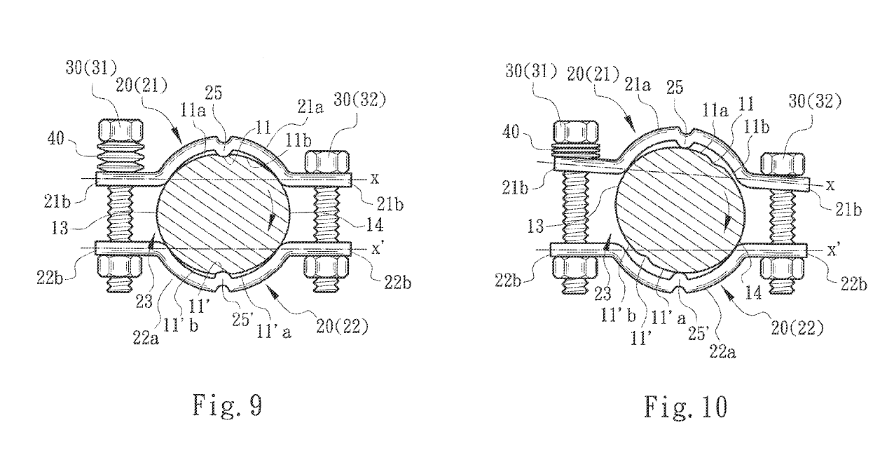

Please now refer to FIGS. 9 and 10. In another modified embodiment of the present invention, the rotary shaft 10 further has a third side 13 and a fourth side 14 formed on the sections of the rotary shaft 10, which sections are free from the restriction sections 11, 11′. The distance between the third side 13 or the fourth side 14 and the center (circular center) of the rotary shaft 10 is longer than the distance between the first side 11a, 11′a or the second side 11b, 11′b and the center (circular center) of the rotary shaft 10. Accordingly, the rotary shaft 10 has a cross section substantially in the form of a cam. In this embodiment, the distance between the first side 11a, 11′a and the center (circular center) of the rotary shaft 10 is equal to the distance between the second side 11b, 11′b and the center (circular center) of the rotary shaft 10. Therefore, when rotating the rotary shaft 10 from the original state, the restriction section 11, 11′ of the rotary shaft 10 is easier to leave the stop section 25, 25′ of the bridge 20 from interference with the stop section 25, 25′. Moreover, when the third and fourth sides 13, 14 of the rotary shaft 10 with longer length (or larger diameter) respectively pass over the stop sections 25, 25′ of the bridge 20, the stop sections 25, 25′ are easier to relatively move toward the first sides 11a, 11′a or second sides 11b, 11′b of the rotary shaft 10 with smaller diameter. Therefore, the rotary shaft 10 in the form of a cam helps in operating or rotating the cover, screen or display for the user to save strength.

In comparison with the conventional device, the rotary shaft structure of the present invention has the following advantages:
1. In the present invention, the rotary shaft 10 and relevant components (such as the restriction sections 11, 11′ of the rotary shaft 10, the stop sections 25, 25′ of the bridge 20, the space or room 23 defined between the pivot sections 21a, 22a of the first and second bridge members 21, 22, the wing sections 21b, 22b, the retainer 30 and the elastic member 40) are redesigned and apparently different from the gaskets and frictional plates of the conventional device. In addition, the restriction sections 11, 11′ and the stop sections 25, 25′ extending along axis y cooperate with each other to form an interference system to improve the defects existing in the conventional device. In the conventional device, raised/recessed locating sections are formed on gaskets and frictional plates as interference structures. Such structures are subject to wear and can hardly achieve reliable locating effect.
2. The assembly of the rotary shaft 10, the first and second bridge members 21, 22, the retainer 30 and the elastic member 40 overcome the problems existing in the conventional device that multiple gaskets and frictional plates are used and it is difficult to assemble these components.
3. The distance between the first side 11a, 11′a and the center of the rotary shaft 10 is unequal to the distance between the second side 11b, 11′b and the center of the rotary shaft 10. In addition, the distance between the third side 13 or the fourth side 14 and the center of the rotary shaft 10 is apparently longer than the distance between the first side 11a, 11′a or the second side 11b, 11′b and the center of the rotary shaft 10. Accordingly, the rotary shaft 10 has a cross section substantially in the form of a cam for a user to save strength in operation.
4. The rotary shaft 10, the bridge 20, the retainer 30 and the elastic member 40 cooperate with each other, whereby the torque can be adjusted by means of the retainer 30. In addition, the bridge 20 has a flexible movement range. Therefore, when rotating the rotary shaft 10, the bridge 20 is expanded and restored to constantly hold the rotary shaft 10. Accordingly, the rotary shaft 10 can be located in a desired angular position immediately after rotated.
5. In the preferred embodiment, the restriction section 11 (or 11′) of the rotary shaft 10 is a channel, while the stop section 25 (or 25′) of the bridge is a ridge section. In a modified embodiment, the forms of the restriction section and the stop section can be exchanged. For example, the restriction section 11 (or 11′) of the rotary shaft 10 can be a ridge section, while the stop section 25 (or 25′) of the bridge 10 is a channel.

The above embodiments are only used to illustrate the present invention, not intended to limit the scope thereof. Many modifications of the above embodiments can be made without departing from the spirit of the present invention.

1. A rotary shaft structure comprising a rotary shaft and a bridge, wherein:
the rotary shaft has at least one restriction section, said rotary shaft being rotatable in opposing directions;
the bridge is provided with at least one stop section corresponding to the restriction section;
the bridge includes a first bridge member and a second bridge member, each of the first and second bridge members being displaced from each other and having a pivot section, the pivot sections together defining a space or room for pivotally connecting with the rotary shaft;
the first and second bridge members are formed with bolt holes; and
at least one retainer is assembled at the bolt holes, said first and second bridge members being further displaceable each with respect to the other responsive to a rotation of said rotary shaft in either of said opposing directions the rotary shaft within the space or room defined by the pivot sections of the first and second bridge members, whereby the restriction section and the stop section are matingly engaged to provide locating effect for the rotary shaft when not rotated, said stop section being slideably engaged with a surface of said rotary shaft during rotation.

2. The rotary shaft structure as claimed in claim 1, wherein the first and second bridge members of the bridge are symmetrical to each other.

3. The rotary shaft structure as claimed in claim 1, wherein the stop section is disposed on the first bridge member.

4. The rotary shaft structure as claimed in claim 1, wherein the first and second bridge members have wing sections, the bolt holes being formed on the wing sections.

5. The rotary shaft structure as claimed in claim 1, wherein the pivot sections of the first and second bridge members have an arcuate cross section.

6. The rotary shaft structure as claimed in claim 1, wherein the first and second bridge members have wing sections positioned in horizontal reference axes, the wing sections extending from two sides of the pivot sections, the bolt holes being formed on the wing sections.

7. The rotary shaft structure as claimed in claim 1, wherein at least one of the retainers is equipped with an elastic member.

8. The rotary shaft structure as claimed in claim 7, wherein the elastic member is compressed at the bolt hole of the first bridge member.

9. The rotary shaft structure as claimed in claim 7, wherein the elastic member is a coil spring.

10. The rotary shaft structure as claimed in claim 8, wherein the elastic member is a coil spring.

11. The rotary shaft structure as claimed in claim 1, wherein the restriction section of the rotary shaft is a channel.

12. The rotary shaft structure as claimed in claim 1, wherein the restriction section of the rotary shaft is a channel extending along an axis of the rotary shaft.

13. The rotary shaft structure as claimed in claim 1, wherein the stop section of the bridge is disposed on the pivot section of the first bridge member in the form of a ridge section.

14. The rotary shaft structure as claimed in claim 1, wherein the restriction section of the rotary shaft and the stop section of the bridge extend along the same axis.

15. The rotary shaft structure as claimed in claim 1, wherein the restriction section of the rotary shaft and the stop section of the bridge extend along the same axis, the restriction section having a length equal to that of the rotary shaft.

16. The rotary shaft structure as claimed in claim 1, wherein the restriction section of the rotary shaft and the stop section of the bridge extend along the same axis, the restriction section having a length equal to that of the rotary shaft, the stop section having a length equal to a width of the bridge.

17. The rotary shaft structure as claimed in claim 1, wherein the rotary shaft is formed with two restriction sections at 180-degree intervals.

18. The rotary shaft structure as claimed in claim 1, wherein the rotary shaft has a first side and a second side defined on two sides of the restriction section, a distance between the first side and a center of the rotary shaft being shorter than a distance between the second side and the center of the rotary shaft.

19. The rotary shaft structure as claimed in claim 1, wherein the bridge is provided with two stop sections formed on the first and second bridge members respectively.

20. The rotary shaft structure as claimed in claim 1, wherein the rotary shaft has a first side and a second side defined on two sides of the restriction section, the rotary shaft further having a third side and a fourth side formed on smooth sections of the rotary shaft adjacent to said first and second sections, a distance between the third side and/or the fourth side and a center of the rotary shaft being longer than a distance between the first side and/or the second side and the center of the rotary shaft.

21. The rotary shaft structure as claimed in claim 1, wherein the rotary shaft has a cross section in the form of a cam.

22. The rotary shaft structure as claimed in claim 1, wherein the rotary shaft has a first side and a second side defined on two sides of the restriction section, a distance between the first side and a center of the rotary shaft being equal to a distance between the second side and the center of the rotary shaft.

23. The rotary shaft structure as claimed in claim 1, wherein the restriction section of the rotary shaft is in the form of a ridge section.

24. The rotary shaft structure as claimed in claim 1, wherein the stop section of the bridge is a channel.

25. The rotary shaft structure as claimed in claim 1, wherein the rotary shaft has the form of a cylindrical body.

26. The rotary shaft structure as claimed in claim 1, wherein the retainer is a bolt.
